(19) United States
(12) Patent Application Publication
(10) Pub. No.: US 2009/0033656 A1
(43) Pub. Date: Feb. 5, 2009

(54) DATABASE DRIVEN RELATIONAL OBJECT MODELING AND DESIGN SYSTEM, METHOD AND SOFTWARE

(76) Inventors: Darren LARKINS, Victoria (CA); Jason Paterson, Victoria (CA); Denis Morais, Victoria (CA)

Correspondence Address: Biotechnology Law Group;c/o Portfolioip, P.O. Box 52050, Minneapolis, MN, 55402, US

(21) Appl. No.: 12/182,115

(22) Filed: Jul. 29, 2008

Related U.S. Application Data
(60) Provisional application No. 60/952,814, filed on Jul. 30, 2007.

(51) Int. Cl. G06T 15/00

(52) U.S. Cl. 345/419

(57) ABSTRACT

The systems, methods, and software of the present invention relate to a database drive relational object modeling and design platform, which addresses the need for a system that allows the design and modification of complex three dimensional objects while doing so in a manner that reduces the requirements for computing power, user training, and man-hours input for design completion. In preferred embodiments, the systems, methods, and software of the present invention provide for a complete end-to-end package that can be used from design initiation to final production, fabrication, and assembly of the designed object.

### CROSS REFERENCE TO RELATED APPLICATION

This application claims the benefit of and priority to commonly owned U.S. provisional patent application Ser. No. 60/952,814, filed 30 Jul. 2007, which is herein incorporated by reference in its entirety for any and all purposes.

### BACKGROUND OF THE INVENTION

1. Field of Invention

The present invention relates generally to the field of three-dimensional object modeling and design, and more specifically to methods, systems, and software for providing a relational database driven three-dimensional (3D) object modeling and design platform which uses geometric elements and references representing the composition of larger geometric elements and the parametric relationships between the geometric elements in a manner that is a direct manipulation of database elements and does not require propagation of information to elicit a change in the parametric object being modeled, to efficiently design/model, or modify complex graphical models.

2. Description of Related Art

Early computer aided design (CAD) engines used coordinate-based geometry to create graphic entities. Editing these graphic entities, which contained only coordinate-based geometry information and no relationship information, was cumbersome and error prone. Production documentation was created in these early design engines by extracting coordinates from the model and generating standalone two-dimensional drawings. As CAD engines became more sophisticated and the computers that ran them became more powerful, the graphical entities created using CAD engines were combined to represent design elements (doors, walls, windows, etc). Additionally, advanced features found in some software allowed the models to become “smart” or “intelligent” by the association of design characteristics or attributes with the model, which allowed for increased ease of editing and for creation of more complex designs or models. However, the result was still a coordinate-based geometric model and modeling system, which was difficult to edit and manipulate and had a tenuous relationship to extracted drawings that easily fell out of synchronization with the model.

Parametric modeling engines came after CAD engines. Parametric modeling engines use parameters (numbers or characteristics) to determine the behavior of a graphical entity and define relationships between model components. An example of this type of relationship information is “12 inch×6 inch rectangular HVAC vent located midway between ceiling edges”. With the addition of the relationship information, design criteria and intent could be captured during the modeling process.

Existing parametric modeling systems and other mechanical computer-aided design and modeling systems (e.g., MCAD systems) manage relationships between dimensions (or parameters) of 3D entities which compose the 3D product data model for which the model or design is being developed. This is often called constraint-based modeling. Typically a great deal of constraint (relationship) information must be included to allow creation of large or complex models that allow recalculation of models and designs to reflect changes that include relationships between dimensions or parameters. Two-dimensional (2D) production information, used for blueprints, design drawings, nesting, and numerically controlled (NC) code generation, is extracted from the 3D objects.

Fully constrained models, as models from constraint-based modelers are sometimes called, are suitable for mechanical designers as the products to be manufactured are typically made from a stock of some material, and thus must be precisely defined. This technology is thus limiting when dealing with the design of an object that is generally a collection of prefabricated components with relatively few constraints that matter to the designer of the final completed object. Objects such as transport vehicles, transport vessels, buildings, etc. fall into this category.

Additional limitations associated with this type of modeling system include extensive training required to master operation of the system, a need for the CAD operator to think in 3D, a requirement for the 3D model to contain all of the complexity required for production details, and a requirement for powerful computers and computing power to render and manipulate the 3D models. Additionally, as the size and complexity of the 3D object being modeled increases, including the number of constraints, there is a significant increase in the computing power needed to efficiently manage design and modeling tasks, otherwise resolving and rendering the model becomes prohibitively slow.

Therefore, the need exists for a three-dimensional modeling and design platform that does not require extensive computing power or training, has the capability to create or modify complex models and resolve and render those models quickly, does not require the designer or CAD operator to think in 3D, can be integrated with third party software or use models and drawings created with third party design tools, and can produce all documentation required for production of all aspects of fabrication and assembly of the designed object.

### SUMMARY OF THE INVENTION

Briefly, the present invention addresses the need for a three-dimensional modeling and design platform with the capability to create or modify complex models and resolve and render those models quickly while not requiring extensive computing power or training. The present invention's patentable systems, methods, and software also provide a three-dimensional modeling and design platform that does not require the designer or CAD operator to think in 3D and thus allows designs to be completed in less time than other design platforms. The present inventions system, methods, and software also provide for a three dimensional modeling and design platform that can be integrated with third party software or use models and drawings created with third party design tools, and can produce all documentation required for production of all aspects of fabrication and assembly of the designed object. The present invention's preferred embodiment is uniquely suited to provide advanced three-dimensional CAD/CAM platform functionality and production documentation, while doing so in a relational database-driven platform whose efficiency is demonstrated in the lower requirements for training, computing power, and man-hours input, while still providing the capacity to create and modify complex three-dimensional models.

In one aspect, the present invention provides a computer program product on a computer readable medium configured to provide a relational database driven three-dimensional (3D) object design/modeling platform. Such databases comprise a plurality of database tables, each of which is comprised of a plurality of rows, each of which represents a distinct geometric element. The relational database is also configured to provide a set of at least two references between rows, wherein the references represent the composition of larger geometric elements and the parametric relationship(s) between the referenced geometric elements. The relational database is also further configured to provide that the creation of, or modification to, geometric elements and/or references in the database, is a direct manipulation of the database and requires no propagation of information to elicit a change in the parametric object being modeled. The relational database is, in effect, the 3D object model, thus any changes made to the model, using geometric elements and/or references in the database, are actually made to the database and are stored as a change to the representation of the parametric object in the database. No updating, resolving, or re-rendering is required for the modeled or modified object to reflect any input by the computer program product user. The visual representation of the model will update as the viewer watches the display. As will be appreciated, 3D modeling and modeling operations are for building representations of three-dimensional objects and encompass any instructions such as graphical programming language or programming of images that can be visualized on two-dimensional displays, holographically, through virtual reality headsets, or by using other display technologies. Alternatively, the models do not need to be visualized but instead can be used for purposes of computation and/or simulation.

In one embodiment the computer program product of the present invention is configured to be used in the design/modeling of a building, manufacturing facility or plant, offshore platform, transport vehicle, transport vessel, or other structure or machine. In a preferred embodiment the computer program product of the present invention is configured to be used in the design/modeling of a vessel or an offshore structure, and may further optionally include, cargo ships, tankers, transport ships, mining ships, ships involved in fishing, salvage operation ships, exploration ships, icebreaker ships, offshore mining structures, offshore oil drilling structures, offshore refueling stations, and offshore exploration platforms. In other embodiments a computer program product of the invention can be used in the design and/or modeling of manufacturing facilities, for example, petrochemical refineries, plants for the production of chemicals, breweries, etc.

In another example, a computer program product of the invention includes one or more of the following additional computer readable program code features in the relational database driven three-dimensional (3D) design/modeling platform: code for administration of design/modeling projects; licensing of the computer product program code; code for a graphical user interface allowing user input of selected client-defined requirements or attributes to specify a configuration of the object to be modeled and/or designed; code acting as a datalayer and application programming interface (API), functioning as an in-memory cache to reduce the need for accessing the relational database; code acting as a datamanager, for managing parametric object datasets; code acting as a session manager, for managing and organizing a plurality of datamanagers such that multiple independent procedures during the design process can be manipulated independently of each other or in conjunction with each other, while still being saved in the relational object database as individual parametric objects or as a larger design/modeling object; code for accessing, designing, modeling, modifying, assembling, and/or saving parametric objects representing a design and/or modeling project; code for analyzing and comparing all parametric object designs or modifications, in order to assure the association between all parametric objects or specific component data sets and geometry is mapped to each respective dataset; code for the output of the design and/or model created using computer program product; code for integration of additional program codes, third party developed or custom user applications, third party developed or custom user design/modeling drawings, and custom parametric objects; and code for producing documentation or commands enabling production of the object designed/modeled using computer program product. In one embodiment a computer program product of the present invention is configured to be used in the design and/or modeling of an onshore or offshore building, platform, structure, transport vehicle, or transport vessel. In a preferred embodiment a computer program product of the present invention is configured to be used in the design and/or modeling of a vessel or an offshore structure, for example, cargo ships, tankers, transport ships, mining ships, ships involved in fishing, salvage operation ships, exploration ships, icebreaker ships, offshore mining structures, offshore oil drilling structures, offshore refueling stations, and offshore exploration platforms. As will be appreciated, the instant invention can also be used in the design and/or modeling of onshore or offshore buildings and manufacturing facilities.

Still further the present invention may optionally include program code or computer program logic further enabling communication between computer readable program codes within the computer, or communication outside of the computer executing the plurality of computer program codes, as well as program code further enabling a hardware-locking feature to monitor the number of active copies or licenses in use by user. The present invention may also optionally provide program code enabling user input of client defined requirements or attributes including, but not limited to: structure (e.g., plant or ship) type, offshore platform type, geometry, materials, weights, grades, revisions, build strategy, connections, paint, and finish.

The present invention may also optionally provide program code enabling the use of a variety of user input devices including, but not limited to: keyboards, mice, graphics tablets, and touch screens, as well as interfaces and associated hardware and/or software for voice recognition. The present invention may also optionally provide program code enabling the computer program product to group similar parametric objects into classes of objects, which are operated on as Active X Data Objects (ADO) datasets in the computer program product, including but not limited to the following object classes: structure, HVAC, equipment, penetrations, pipe, nest, shared, profile plot, hull, and product hierarchy.

The present invention may also optionally provide program code enabling control and manipulation of classes of similarly grouped parametric objects. The present invention may also optionally provide program code enabling implementation of parametric object class design patterns that allows integration into design/modeling drawings compatible with other design/modeling software. The present invention may also optionally provide program code enabling control and manipulation of a plurality of similarly grouped parametric object classes as a collection object. The present invention may also optionally provide program code enabling a session manager, that is program code for the control and manipulation of a plurality of datamanager collection objects.

The present invention may also optionally provide program code enabling organization of the plurality of datamanager collection objects under its control by mapping each object to an instance of an AutoCAD drawing. The present invention may also optionally provide program code allowing user control of global or local application and dispersion of modifications to previously defined geometric elements and/or references used in the design or modification of parametric objects or specific components. The present invention may also optionally provide program code that allows changes in a geometric element and/or reference, used in the design or modification of any parametric object or specific component within the database, to elicit a corresponding modification to the visual representation of parametric objects or specific components with shared geometric elements and/or references in the object being modeled. The present invention may also optionally provide program code enabling two- or three-dimensional extrapolation and visualization of the design/modeling project from geometric element and reference information representing the parametric object being designed and/or modeled, as well as for visualization of the design/modeling output on a display or other output device including, but not limited to, electronic displays, plotters, printers, viewing displays such as liquid crystal displays (LCDs) and other flat-panel monitor types, and CRT-based viewing displays. The present invention may also optionally provide program code enabling import and/or export of modeling/design drawing or project data to and/or from third party design/modeling software. The present invention may also optionally provide program code enabling numerically controlled (NC) code generation from CAD DXF files for computer controlled manufacturing applications, and also further optionally provide for the conversion of CAD DXF drawings to NC code.

In another aspect, the present invention provides methods for designing a three-dimensional object using a computer configured to execute computer program logic that utilizes a relational database according to the invention in order to design the 3D object. Such methods typically utilize the steps of:
a) planning the production of the three-dimensional object;
b) designing and modeling within computer memory the three dimensional object using a plurality of geometric elements, each of which is represented by a row in a relational database, and also using a plurality of references between rows, wherein said references represent the composition of larger geometric elements and the parametric relationship between the geometric elements; and optionally
c) producing documentation to enable fabrication and assembly of the designed/modeled three-dimensional object.

This aspect of the invention may also optionally provide additional steps that allow the user to enter specific or custom requirements by defining attributes to one or more parametric objects or specific components used in the design/model project. These additional steps can include one or more of the following:
d) inputting selected client requirements to specify a configuration for a three dimensional object; and/or
e) defining parametric object attributes, using geometric elements and references, to be used for assembly of a complete three dimensional object, wherein each of the parametric objects represents a specific component, part, or sub-assembly of the three dimensional object to be modeled.

The present invention may also optionally provide additional method steps that allow for the user to modify the design of a 3D object, including pre-existing designs and/or drawings imported from other CAD/CAM software, using a computer configured to execute computer program logic adapted for such purposes. The methods for modifying the design of 3D objects may thus optionally use one or more of the following steps:
f) identifying at least one previously defined geometric element and/or reference of a three-dimensional object design to be modified;
g) modifying said identified geometric element(s) and/or reference(s), within computer memory, using at least one of a plurality of geometric elements, each of which is represented by a row in the database, and also using at least one of a plurality of references between rows, wherein said references represent the composition of larger geometric elements and the parametric relationship between the geometric elements; and optionally
h) producing documentation to enable fabrication and assembly of the modified three-dimensional object.
   The method further provides for user definition or modification of parametric object attributes or other elements of the relational database being employed in the particular circumstance, thereby allowing for the local or global application and dispersion of modifications made to the objecting being modeled.

The present invention also optionally provides additional or alternative method steps that allow for the user to enter specific or custom requirements by defining attributes to one or more parametric objects or specific components of a 3D object to be modeled. Such optional additional or alternative steps include one or more of the following:
i) defining parametric object attributes, using geometric elements and references, to be used for assembly of a complete three dimensional object, wherein each of the parametric objects represents a specific component of the three dimensional object to be modeled; and/or
j) inputting selected client requirements and parametric object attribute modifications to specify a configuration for at least one modified component(s) of a three dimensional object to be modeled.

In one embodiment the method of the present invention described herein may be used in the design and/or modeling of an onshore or offshore building, platform, or other structure, as well as transport vehicle or transport vessel. In a preferred embodiment, the invention is used in the design and/or modeling of a vessel or an offshore structure, such as, for example, a cargo ship, tanker, transport ship, mining ship, ship involved in fishing, salvage operations, and/or exploration, an icebreaker ship, an offshore mining or oil drilling structure, an offshore refueling station, and an offshore exploration platform. As those in the art will understand, the invention can also be used to design and/or model one or more of a plurality of sub-components, objects, or object groupings for any such structures, including but not limited to, HVAC units and duct work, equipment, component penetration(s) into a larger structure or sub-assembly, pipe, hulls, bulkheads, propulsion units, etc., while also providing for the user input of attributes including, but not limited to, geometry, materials, weights, grades, revisions, build strategy, connections, paint, and finish. In preferred embodiments, one or more selected client requirements and parametric object attributes in the database can be modified by a user in order to specify, for example, a configuration for 3D objects to be modeled.

In yet another aspect, the present invention provides systems for database-driven design and/or modeling, which systems includes a computer configured to execute computer program logic that utilizes a relational database according to the invention, which database comprises a plurality of tables, which tables each comprise a plurality of rows. Each row represents a distinct geometric element. Between rows in a table is disposed a set of references representing a composition of at least two geometric elements and references representing the parametric relationship between at least two of those referenced geometric elements. Furthermore, in some embodiments of a relational database of the invention a user may create or modify the parameter(s) associated with a geometric element or geometric element reference. As those in the art will appreciate, in so doing the user directly manipulates the database, and as a result there is no requirement that the new or modified information or data be propagated in order to elicit a change in the parametric object being modeled.

Systems of the invention can further be optionally configured to provide one or more additional computer readable program code features to the relational database driven 3D design/modeling platform, including without limitation: code for administration of design/modeling projects; licensing of the computer product program code usage; code for a graphical user interface to allow user input of selected client-defined requirements or attributes to specify a configuration of the object to be modeled or designed; code acting as a datalayer and/or application programming interface (API), functioning as an in-memory cache, to reduce the need for accessing the relational database; code acting as a datamanager, for managing parametric object datasets; code acting as a session manager, for managing and organizing a plurality of datamanagers such that multiple independent procedures during the design process can be manipulated independently of each other or in conjunction with each other, while still being saved in the relational object database as individual parametric objects or as a larger design/modeling object; code for accessing, designing, modeling, modifying, assembling, and saving parametric objects representing a design/modeling project; code for analyzing and comparing all parametric object designs or modifications, in order to assure the association between all parametric objects or specific component data sets and geometry is mapped to each respective dataset; code for the output of the design/model created using computer program product; code for integration of additional program codes, third party developed or custom user applications, third party developed or custom user design/modeling drawings, and custom parametric objects; and code for producing documentation or commands enabling production of the object designed/modeled using computer program product.

In still another example, the present invention provides methods of providing a relational database-driven designing/modeling or modifying system which methods comprise providing a computer configured to execute computer program logic that utilizes a relational database according to the invention in order to design or model the parametric object or structure to be designed and/or modeled. Such methods may also optionally comprise use of a first computer readable program code for administration of design/modeling projects and licensing of the computer product program code usage, (and communication between user computer and database licensor), a second computer readable program code for a graphical user interface allowing user input of selected client defined requirements or attributes to specify a configuration of the object to be modeled/designed, a third computer readable program code acting as an in-memory cache to reduce the need for accessing relational database (Datalayer API), a fourth computer readable program code for managing parametric object datasets (Datamanager), a fifth computer readable program code for managing and organizing a plurality of Datamanagers (Session Manager) such that multiple independent procedures during the design process can be manipulated independently of each other or in conjunction with each other, the manipulated datasets being saved in the relational object database as individual parametric objects or as a larger design/modeling object, a sixth computer readable program code for accessing, designing, modeling, modifying, assembling, and saving parametric objects representing the design/modeling project, a seventh computer readable program code for analyzing and comparing all parametric object designs or modifications, such the association between all parametric object or specific component data sets and geometry being mapped to each respective dataset, an eighth computer readable program code for output of the design/model so created, a ninth computer readable program code for integration of additional program codes, third party developed or custom user applications, third party developed or custom user design/modeling drawings, and custom parametric objects, and a tenth computer readable program code for production of the object designed/modeled using computer program product.

In a preferred embodiment, the methods of the invention can be used to modify the design of a previously modeled 3D object for which a relational database according to the invention was created during the design of the previously modeled 3D object. Such methods typically comprise the following steps:
planning the production of a particular three-dimensional object to be designed or modeled;
computationally designing and modeling the particular three-dimensional object using a relational database according to the invention that defines the particular three-dimensional object;
identifying for modification at least one previously defined geometric element and/or geometric element reference for the three-dimensional object;
modifying the identified geometric element(s) and/or geometric element reference(s) in the existing relational database for the 3D object; and
producing documentation to enable fabrication of the designed/modeled three-dimensional object.

As those in the art will appreciate in view of this specification, the systems of the present invention may also optionally provide additional steps that allow a user to enter specific or custom requirements for one or more parts or sub-assemblies of the object to be designed and/or modeled. In such instances, the user can define the attributes of one or more parametric objects or specific components of the 3D object to be modeled. Typically this accomplished by defining parametric object attributes using geometric elements and references, wherein each of the parametric objects represents a specific component of a larger three-dimensional object to be modeled. After definition, these parametric object attributes, be they the specification of a new or otherwise previously undefined component or a previously modeled 3D object or a modification of or to one or more already or previously defined component(s) of a three dimensional object to be modeled.

The foregoing and other aspects of the invention will become more apparent from the following detailed description, accompanying drawings, and the claims.

### BRIEF DESCRIPTION OF THE DRAWINGS

The drawings are provided for purposes of illustration only and not limitation. It should be noted that for clarity and ease of illustration, these drawings are not made to scale and that in some instances various aspects of the invention may be shown exaggerated or enlarged to facilitate an understanding of the invention. Various exemplary embodiments of the present invention will be described in detail, with reference to the following figures, wherein:

FIG. 1 is a block diagram illustrating the geometric elements and references comprised in a parametric object, and their relationship to each other in accordance with the present invention;

FIG. 2 is an illustration of a design drawing for creating parametric objects with shared geometric elements and references, created in accordance with the preferred embodiment of the present invention;

FIG. 3 is an illustration of the DDROM relational database of the present invention and its relationship to model drawings created in accordance with the preferred embodiment of the present invention;

FIG. 4 is a block diagram illustrating various aspects of the present inventions computer program product (software) as used in a system performing the method of the preferred embodiment of the present invention;

FIG. 5 is a block diagram illustrating in further detail various aspects of the present inventions software as used in a system performing the method of the preferred embodiment of the present invention; and

FIG. 6 is a flow chart illustrating the design process for a three dimensional object, more particularly a vessel or ship, in accordance with the preferred embodiment of the present invention.

### DEFINITIONS

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

Geometric element: Points, lines or transformation matrices (geometric or mathematical concept or operation performed on a point or line), represented by a row in a database table (i.e., tuple). A geometric element may also be an assemblage of points, lines, and other geometric shapes created from points and/or lines, or larger objects comprised of points lines, transformations and other geometric shapes.

Relational database row reference: References between rows of one or more relational database tables representing the composition of larger geometric elements (also described as rows), and the parametric relationship between geometric elements within the database table rows

Parametric object: A geometric object created of geometric elements and references, and which also includes built in geometric dependencies (if any portion of the object is shared with any other parametric object). The built in geometric dependencies allow any modification to be reflected immediately throughout the object model, should the user so choose.

Parametric modeling: A method of defining geometry in which geometric dependencies are built in.

Relational database driven parametric object modeling: A method of creating, defining, or modifying the geometry of a three dimensional object, using a relational database, in which database table rows represent geometric elements, and relational database row references represent the composition of larger geometric elements, and the parametric relationship between geometric elements within the database table rows, to model objects with three dimensional geometry in which the geometric dependencies and relationships are built in.

Geometric Transform or Transformation: Any of a variety of different functions from geometry or mathematics, which can be carried out in Euclidean space, particularly in 2 or 3 dimensions, on a set of points which define a geometric entity. Examples of transformations are; rotation, translation, mirror, identicality, and scaling.

Patentable: a process, machine, or article of manufacture of the invention that satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the non-patentable embodiment(s). Also, the claims appended hereto are to be interpreted both to provide the broadest reasonable scope, as well as to preserve their validity. Furthermore, the claims are to be interpreted in a way that (1) preserves their validity and (2) provides the broadest reasonable interpretation under the circumstances, if one or more of the statutory requirements for patentability are amended or if the standards change for assessing whether a particular statutory requirement for patentability is satisfied from the time this application is filed or issues as a patent to a time the validity of one or more of the appended claims is questioned.

Plurality: more than one.

Polyline: A continuous line composed of one or more line segments. A polyline can be created by specifying the endpoints of each segment, and can be treated as either a single continuous line or as its component segments. For example, a construction line used in the design process is a polyline entity that is stored in the database and can be used to define the boundary portions of a part.

Polyline geometry: A continuous line describing a geometric element or shape created using one or more line segments.

Custom object or custom parametric object: An intelligent object that represents higher level objects in the DDROM created from lower level geometric elements. Essentially an assemblage or association of a number of lower level objects, created from geometric elements, in the DDROM.

### DETAILED DESCRIPTION OF THE INVENTION

Detailed descriptions of examples of the invention are provided below. It is to be understood, however, that the present invention may be embodied in various forms. Therefore, the specific details disclosed herein are not to be interpreted as limiting, but rather as a representative basis describing to those skilled in the art how to make and use the present invention in any system, structure, or manner adapted or otherwise configured for carrying out the invention.

The patentable database driven relational object modeling and design systems, methods, and software of the present invention provide novel, non-obvious solutions to the problem of efficiently making changes to datasets representing complex graphical models. The present invention requires less computing power than conventional three-dimensional computer aided design/computer aided manufacturing (CAD/CAM) platforms due to the nature in which the components of the object being modeled are stored and used by a computer configured to execute software and manipulate and process data accessible in a relational database according to the invention for the particular object. Such relational databases the computer readable code of the computer program product (i.e., software). In effect, the database represents the 3D object being modeled. All work performed using the systems, methods, and softwares of the present invention is done on a specific project. A project represents a single object to be designed. In one embodiment of the invention the project represents a single object such as a structure, platform, transport vehicle or transport vessel. In the preferred embodiment of the present invention, the project represents a vessel or an offshore structure, and may further optionally include, cargo ships, tankers, transport ships, mining ships, ships involved in fishing, salvage operation ships, exploration ships, icebreaker ships, offshore mining structures, offshore oil drilling structures, offshore refueling stations, and offshore exploration platforms. It should be noted that 3D modeling and modeling operations are for building representations of three-dimensional objects and encompass any instructions such as graphical programming language or programming of images that can be visualized on two-dimensional displays, holographically, through virtual reality headsets and other display technologies. Alternatively, the models do not need to be visualized but instead could be used for purposes of computation, and simulation. It will also be appreciated by those of ordinary skill in the art that the invention could also be used in conjunction with any computer-aided design software, including software used to generate two-dimensional models. The present invention operates on a computer system containing processors, display units, storage units, communications functions and other hardware, software and firmware necessary to carry out the normal operations of a computer system. While the present invention is a system, method and software platform that operates on a computer system, computers, processors and storage units are well known in the art and will not be described herein. It will be appreciated that computing device, chip design, and processor design are continuously evolving and improving. It will also be appreciated that as technology and user requirements change processors of increasing complexity and power are easily substituted for processors currently in use. Therefore it will be understood that the present invention includes processor designs and technologies not currently available.

Work on projects performed using the systems, methods, and software of the present invention is done within computer-generated drawings. Each drawing is an interface between the user and the data set(s) representing the model or project stored in the database. Preferably, whenever a drawing or rendering created using the software of the present invention is opened, the software regenerates the drawing using the information in the database. Any change(s) made to a drawing are not saved to the database until the drawing is saved. Once the drawing is saved, changes made to the drawing are then applied to the database, and the database immediately reflects those changes without the need for the software to apply the change to other drawings. The relational nature of the database is ideal for modeling the relationships between the geometry of a design and the parts comprising the project, as well as the ideal location for storing the design geometry due to the required interaction between objects in different design drawings. A model created in this manner is a three dimensional representation of the entire object being designed. Each project contains many modeling or design drawings, but only one model. Modeling or design drawings can be imported from or exported to third party CAD/CAM software. In the preferred embodiment of the invention, AutoCAD drawing objects become a dynamic representation of the geometry and relationships modeled in the database. The methods, system and software of the present invention enables design projects from the planning stage to the production documentation stage, for efficient fabrication and assembly of the designed object. As used herein the terms “model drawing” or “drawing” refers to computer-generated data stored on or in a data storage medium. The invention may be implemented in digital electronic circuitry, or in computer hardware, firmware, software, or in combinations thereof. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

The gains in efficiency seen with the methods, systems, and software of the invention, with regard to computing power requirements and man-hours input per project, are due to the fundamentally new technology used in creating, storing, and updating part information: the Database Driven Relational Object Model (DDROM). DDROM is a definition of how the totality of information comprising an object being modeled is stored, as well as how the totality of information can be related depending on how it was stored. The information in the DDROM is stored in database tables. The information making up the DDROM can take many forms. Examples of some of the types of information stored within the database tables of the DDROM are; geometric elements (points, lines, geometric shapes, geometric or mathematical transforms or transformations, to name just a few as example), attributes (color, finish, thickness, grade, material, weight, etc.), object class (structure type (e.g., onshore or offshore building or structure, for example, onshore petroleum refinery, offshore drilling platform, ship, etc.), HVAC (heating, venting, air conditioning), Equipment, Penetrations, Pipe, Nest, Shared, Profile Plot, Hull, to name just a few as example) and object interaction. Databases and relational databases are well known in the art and will not be described in detail herein. However, aspects of database functionality used to help enable the present invention will be described.

Each database table contains one or more rows of information for a type of concept or item the table is configured to hold. For example, a database table may hold information for a geometric element. A single row of information might comprise coordinate geometry information defining the shape (points and lines), the number of times the shape is used in a drawing or model, the location of each instance of the shape in terms of a transform that refers back to the original shape, or conversely refers to some point of origin. Additional information associated with this particular geometric element can include but is not limited to references to attributes, stock, revisions, and object classes. The additional information is in the form of a reference, where references point to other database tables containing information for a different type of concept or item. References themselves represent the composition of larger geometric elements (also contained in rows representing geometric elements), and the parametric relationship between the geometric elements represented by the various database table rows. The references are connectors between table elements, geometric elements, transformations, parametric relationships and assemblages of a plurality of table elements, geometric elements, transformations and parametric relationships (i.e., custom objects or custom parametric objects). Thus, the database becomes the object being modeled by virtue of the totality of information stored in the database in conjunction with the relationships between all the information and the manner in which data is read and written to the database through procedures stored in the database. All access to database tables occurs through procedures also stored in the DDROM.

Since the database represents the object being modeled, all design information comprising a project is stored within the database for a given 3D object. In the eventuality that all design drawings are lost or deleted, the entire project can be restored from the information stored in the DDROM database tables, including third party CAD/CAM drawings and production information as well as numerically controlled (NC) code generation from CAD DXF files for computer controlled manufacturing applications. Additionally, the creation of, or modification to, geometric elements and/or references in the database, is a direct manipulation of the database and requires no propagation of information to elicit a change in the parametric object being modeled. That is, if two or more items in the model share the same boundary they will all have a reference to the representation of that boundary in the database. In database terms, for parts that share the same polyline geometry, each tuple (i.e., row in a database) in the part relation references the same tuple in the polyline relation. Changing the data that represents the polyline tuple represents a change in all of the identical parts without the need for the software of the present invention to go through and make any additional changes. These relation references persist at all levels of the drawings and project, such that when a part that shares a boundary with other parts is moved, all objects within that group of parts that share a boundary are modified as well. Modification to a part used throughout a design will elicit a change to every instance of that part, unless the user limits the dispersion and application of that modification. This is accomplished by duplicating the tuple being modified, and using the modified tuple for that particular aspect of the design.

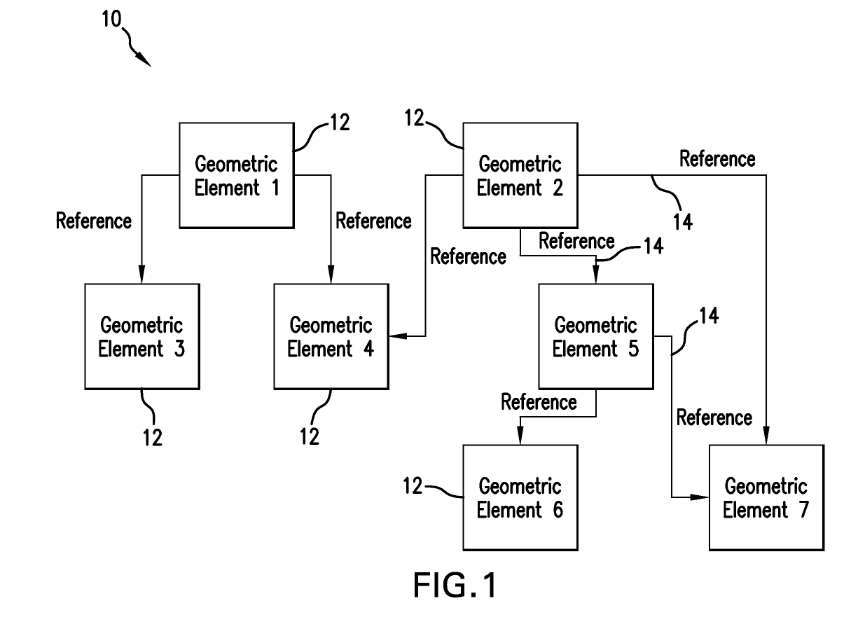

Aspects of the geometric elements and relationships comprising the DDROM are further described in conjunction with reference to the Figures. Referring now to FIG. 1, it is a block diagram conceptually illustrating several geometric elements and references that make up a parametric object, and their relationship to each other in accordance with the present invention. The parametric object 10 illustrated in FIG. 1 comprises geometric elements 12, and references (connectors) 14. The geometric elements 12 comprise points, lines, geometric shapes, and geometric or mathematical transforms or transformations. The points and lines can be further combined to create various geometric shapes useful in modeling or design, for instance rectangles, triangles, circles, and arcs to name only a few. Geometric shapes can also be further combined to create geometry of increased complexity if necessary. Geometric or mathematic transforms also allows the creation or modification of geometric elements and shapes. For instance, lines and points may be used to create a shape, which then can be duplicated (identicality transform) thereby creating a second shape, identical to the first. In the database, there exists only the original geometry based on the geometric elements 12 used to created that geometry, but additionally the database now contains reference information 14, in the form of position information, relative to either the original shape or a point of origin, that identifies the location of the duplicated shape. Geometric or mathematical transforms are well known and will not be described in detail herein. Examples of transforms useful in the system, method and software of the present invention include, but are not limited to, rotation, translation, mirror, identicality, and scaling.

The geometry created using geometric elements 12 exists in a database table specific for that geometry. Reference data or information 14 also exists in the database in a table specific for that reference information. Examples of reference information 14 useable with the preferred embodiment of the methods, systems, and software of the present invention include, but are not limited to, attributes (e.g., color, finish, thickness, grade, material, weight, to name just a few as example), object class (Structure, HVAC, Equipment, Penetrations, Pipe, Nest, Shared, Profile Plot, Hull, to name just a few as example), and object interaction. One of skill in the art will appreciate that a listing of every possible attribute, object class, and object interaction useable for the design and modeling of vessels or offshore structures is beyond the scope of the present invention. Therefore it will be understood that any attribute useful for the design, modeling, modification, fabrication, and final assembly of a three dimensional object in accordance with the teachings of the present invention are envisioned to be included by the present invention.

The parametric object 10 stored in the database also illustrates an additional benefit of the instant systems, methods, and software. For instance, geometric elements 12 may at times share a boundary. Additionally, various aspects of the object being designed may also share boundaries or borders. The shared boundaries, which can take the form of shared points or lines, of geometric elements 12, are stored in the database as a reference 14 to other geometric elements. In FIG. 1, geometric element 5 (12) can be seen to have 3 references 14 which either point to it, or point to another geometric element from geometric element 5 (12) (from geometric element 2, to geometric elements 6 and 7). The reference 14 can include information regarding points or lines shared between different shapes or portions of a design. This is an example of using the DDROM to model both the geometry and the interdependencies or relationships between the geometry, and shows how if two or more items in the model share a boundary, they will all have a reference to the representation of that boundary in the database.

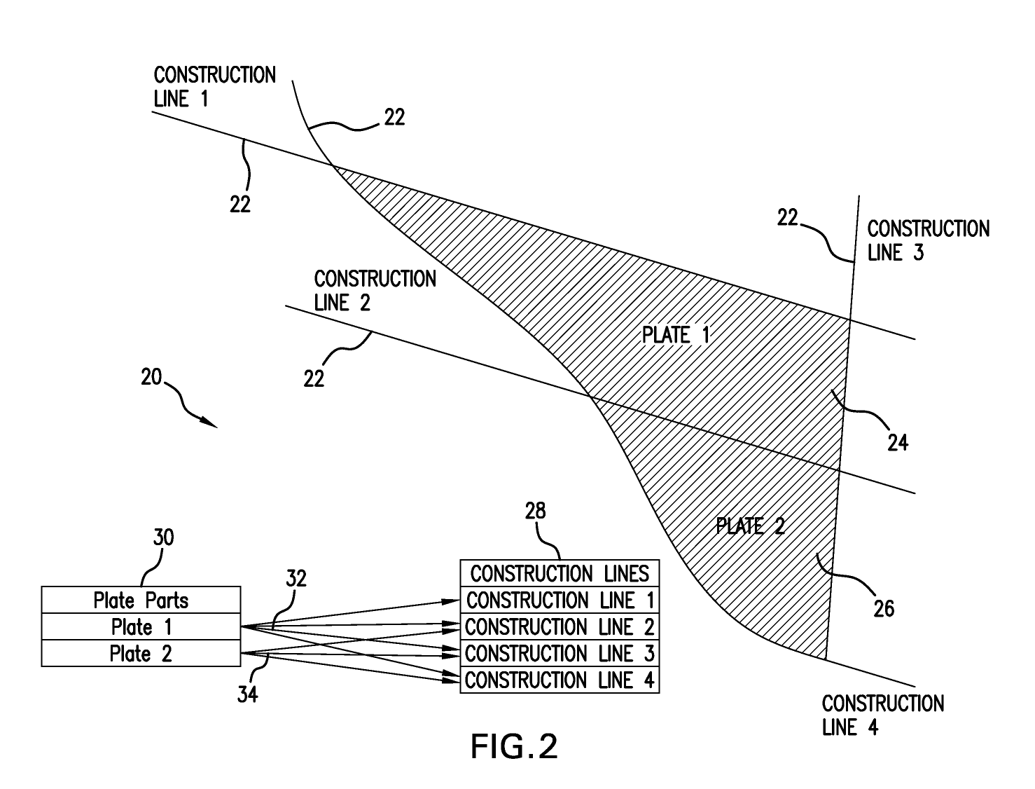

Referring now to FIG. 2, it is an illustration of a model or design drawing 20 for creating parametric objects with shared geometric elements and references in accordance with a preferred embodiment of the present invention. Design drawing 20 illustrates the use of geometric elements, in the forms of construction lines 22 (e.g., construction lines 1, 2, 3 and 4), being used to form the boundaries of 2 parts to be used in the design of a ship. The 4 construction lines 22 form 2 plate parts, plate 1 (24) and plate 2 (26). Plate 1 (24) is formed by construction lines (22) 1, 2, 3, and 4, whereas plate 2 (26) is formed by construction lines (22) 2, 3 and 4. In the DDROM, a database table, named Construction Lines 28, exists that contains the geometric elements, and reference information if any, that comprise the various construction lines. Additionally, a database table called Plate Parts 30 exists that contains the various plate parts designed using geometric elements. References connect the plate part database table 30 to the construction line database table 28. These references or connectors are illustrated in FIG. 2 as the unidirectional arrows 32 and 34. Plate 1 (24) contained in plate part database table 30 references 32 construction lines 1, 2, 3 and 4 (22) in construction line database table 28. Plate 2 (26) contained in plate part database table 30 references 34 construction lines 2, 3 and 4 (22) in construction line database table 28. Therefore plate 1 (24) and plate 2 (26) share the boundaries of construction lines 2, 3, and 4 (22). It will be appreciated from this figure that complex shapes can be created using simple geometric elements using the system, method and software of the present invention, as well as creating relationships between the shapes and component geometric elements that make up the shapes. Additionally, database tables exist in the DDROM that contain information regarding geometric elements or shapes with shared boundaries.

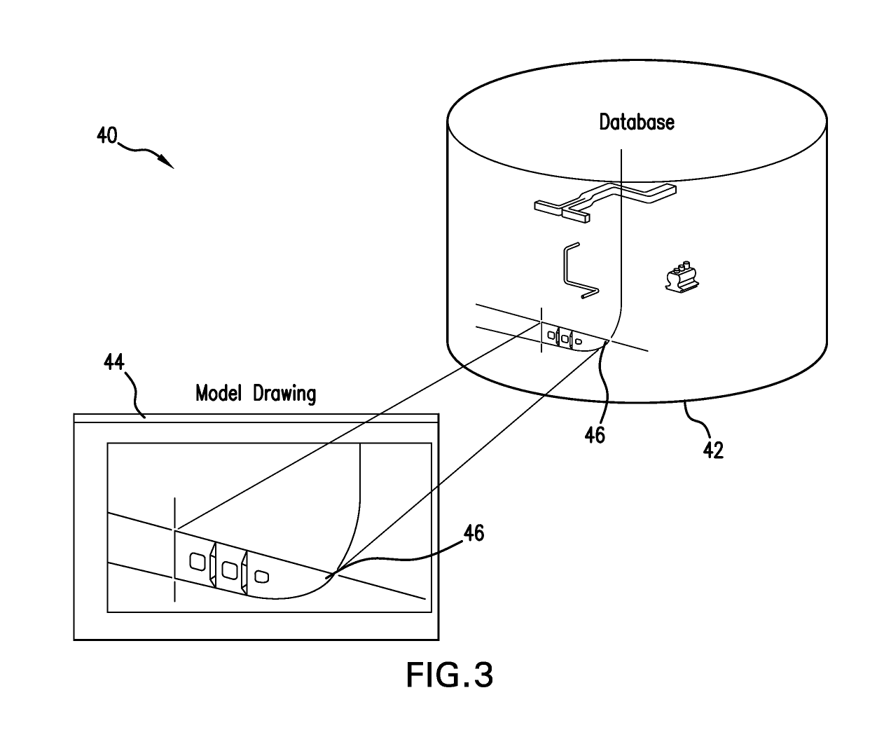

Referring now to FIG. 3, it shows an illustration of a DDROM relational database of the present invention and its relationship to model drawings created in accordance with the preferred embodiment of the present invention. Work on projects performed using the system, method, and software platform 40 of the present invention is accomplished by a user referencing a rendering of model drawings 44, which is depicted in the inset shown in FIG. 3 as a screen shot of what the user might see on a computer monitor during this process. Each drawing is an interface between the user and the model or project stored in the database 42. The relational nature of the database 42 is ideal for modeling the relationships between the geometry of a design and the parts comprising the project, as well as the ideal location for storing the design geometry due to the required interaction between objects in different design drawings. The model created in this manner is a three dimensional representation of the entire object being designed. Each project contains many design or modeling drawings 44, but only one model. Through the use of the methods, system, and software platform 40 of the invention, the database 42 takes on the attributes of the object (and its component parts) being modeled through the creation of model drawings 44 and the reference relationship 46 of the model drawings 44 to the database 42. The database 42 comprises the data representing the object being modeled. The creation of, or modification to, geometric elements, or more complex geometry and/or reference relationships 46 in the database 42, through model drawings 44, is a direct manipulation of the database 42 and eliminates the need for the software platform 40 of the present invention to propagate, resolve, or re-render any of the modifications to elicit a change in the parametric object being modeled.

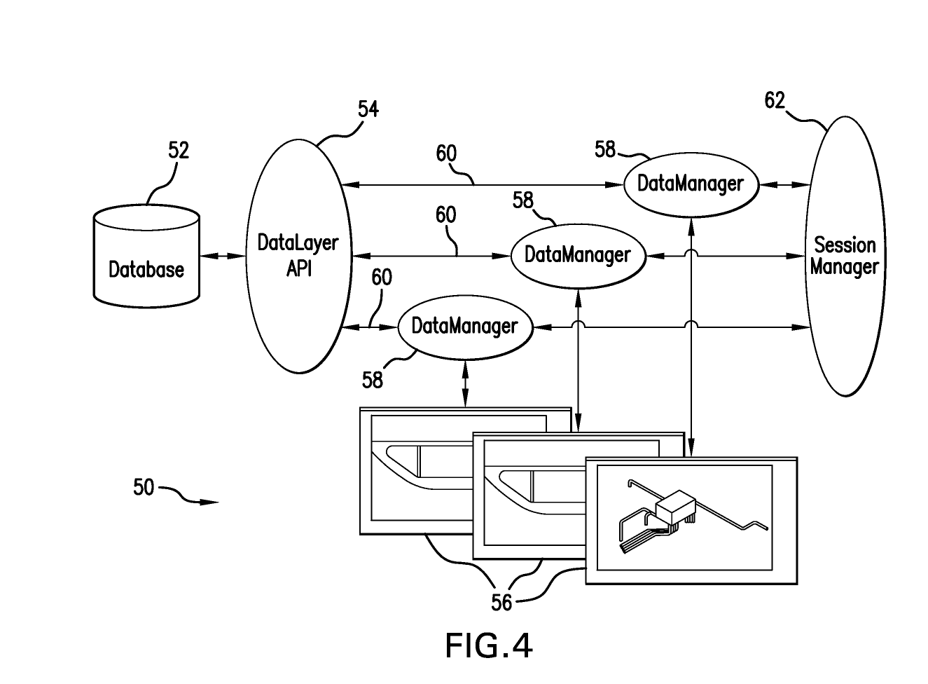

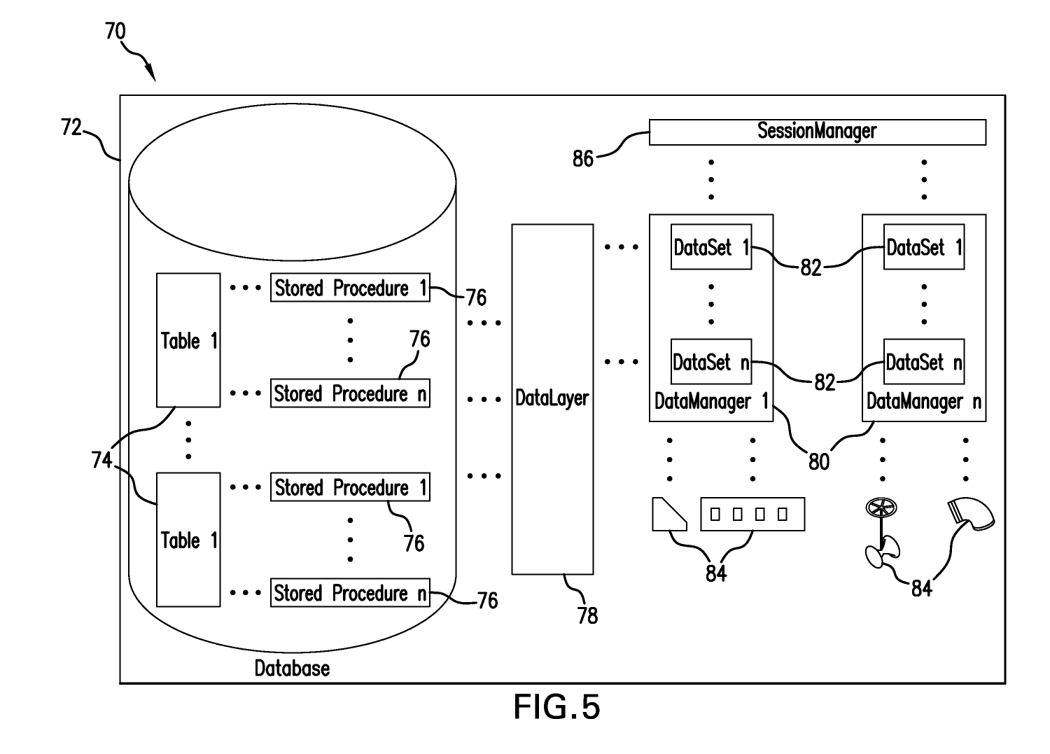

Turning now to FIGS. 4 and 5, these figures illustrate various aspects of the present invention's software as used in a system performing a preferred embodiment of the present invention. The present invention's database driven relational object model design platform (FIG. 4, 50, and FIG. 5, 70) comprises a computer configured to execute computer program logic that utilizes a relational database (FIG. 4, 52 and FIG. 5, 72) stored in a suitable medium for electronic data storage that can be accessed by the computer. The relational database (FIG. 4, 52 and FIG. 5, 72) comprises rows within the database tables (FIG. 5, 74), each of which represents a geometric element, and a set of references between rows, said references further comprising references representing the composition of larger geometric elements and references representing the parametric relationship between the geometric elements and wherein the creation of, or modification to, geometric elements and/or references in the database, is a direct manipulation of the database (FIG. 4, 52 and FIG. 5, 72) and requires no propagation of information to elicit a change in the parametric object being modeled.

In this embodiment, the present invention's DDROM design platform (FIG. 4, 50 and FIG. 5, 70) further comprises Datalayer (FIG. 4, 54 and FIG. 5, 78) program code acting as an in-memory cache in order to reduce the need for accessing the database. The database driven relational object model design platform (FIG. 4, 50 and FIG. 5, 70) stores the majority of its persistent data in a database (FIG. 4, 52 and FIG. 5, 72). In the preferred embodiment of the invention, the database (FIG. 4, 52 and FIG. 5, 72) is a Microsoft SQL database. To reduce the need for constantly accessing the database to retrieve information in this embodiment, the database driven relational object model design platform computer program code additionally provides a Datalayer that consists of a set of classes that behave as Active X Data Objects (ADO) datasets.

The block illustrating the Datalayer program code in FIG. 4 (54) also contains program code for an Application Programming Interface (API). Application programming interface program code 54 allows integration of computer program code (software) updates from the computer program product manufacturer, as well as providing a means for integration of third party vendor applications, plug-ins, add-ons, and the like. API program code acts in conjunction with the other executable program codes contained within software as necessary for functionality. Application programming interfaces useful for adding third party vendor applications, plug-ins, or add-ons, as well as being useful for allowing software updates provided by the particular software manufacturer, are well know and will not be discussed in detail herein.

The database driven relational object model design platform (FIG. 4, 50 and FIG. 5, 70) allows work to be performed on the project or object being modeled through model drawings 56. Model drawings 56 are linked to each other and to the project through DataManager (FIG. 4, 58 and FIG. 5, 80) program code, and the flow of reference and geometry data (FIG. 4, 60) between the model drawings (FIG. 4, 56) that contain parametric objects or custom parametric objects (FIG. 5, 84) added by the user, the DataManager (FIG. 4, 58 and FIG. 5, 80) program code and database (FIG. 4, 52 and FIG. 5, 72) through the DataLayer (FIG. 4, 54 and FIG. 5, 78) program code. The parametric objects or custom parametric objects (FIG. 5, 84) are handled within the DataManager (FIG. 4, 58 and FIG. 5, 80) program code as datasets (FIG. 5, 82), where each object (FIG. 5, 84) in a model drawing (FIG. 4, 56) is represented by its own dataset (FIG. 5, 82), and each model drawing (FIG. 4, 56) and all geometric and reference data for each part is handled by a DataManager (FIG. 4, 58 and FIG. 5, 80).

All access to the DDROM database (FIG. 4, 52 and FIG. 5, 72) tables (FIG. 5, 74) occurs through procedures (FIG. 5, 76) also stored in the DDROM database (FIG. 4, 52 and FIG. 5, 72). DataManager (FIG. 4, 58 and FIG. 5, 80) program code further enables efficient management of parametric object datasets. DataManagers (FIG. 4, 58 and FIG. 5, 80) own or control the instances of classes that behave as ADO datasets. The DataManager (FIG. 4, 58 and FIG. 5, 80) program code also implements design patterns that allow them to be easily integrated into the AutoCAD concept of drawings. DataManager (FIG. 4, 58 and FIG. 5, 80) classes are generally characterized by the optionally provided modules they support. In the preferred embodiment of the present invention, examples of the DataManager (FIG. 4, 58 and FIG. 5, 80) classes include, but are not limited to, Structure, HVAC, Equipment, Penetrations, Pipe, Nest, Shared, Profile Plot, Hull, and Product Hierarchy. A part (specific component or parametric object designed or modified using the system, method, and software of the present invention, or imported to be used in the system, method, and software of the present invention) will persist itself in the database (FIG. 4, 52 and FIG. 5, 72) of the present invention by maintaining a corresponding set of data records in DataLayer (FIG. 4, 54 and FIG. 5, 78) objects. Using an example from the preferred embodiment of the present invention, a plate part to be used in the design and fabrication of a vessel or offshore structure will maintain a record in a STRUCT_PlateParts DataLayer (FIG. 4, 54 and FIG. 5, 78) object that is accessed via the DataManager (FIG. 4, 58 and FIG. 5, 80) class for structures.

The DataManagers (FIG. 4, 58 and FIG. 5, 80) are themselves owned or controlled by a Data Manager Collection object (DataManagerCollection), which in turn is owned or controlled by a DataManagerCollections object. The DataManagerCollections object is maintained by the SessionManager (FIG. 4, 62, and FIG. 5, 86). The SessionManager (FIG. 4, 62, and FIG. 5, 86) is a single entity that maintains one instance of a DataManagerCollections object, such that multiple independent procedures during the design process can be manipulated independently of each other or in conjunction with each other, the manipulated datasets (FIG. 5, 82) being saved in the relational database (FIG. 4, 52 and FIG. 5, 72) as individual parametric objects (FIG. 5, 84) or as a larger design/modeling object (FIG. 4, 56). The DataManagerCollections class organizes the DataManagerCollection objects under its control by mapping each to an instance of an AutoCAD drawing. The DataManagerCollection objects controlled by a DataManagerCollections class are mapped to AutoCAD drawings by using a model drawing information object (SconDwgInfo) present in every AutoCAD drawing created using the software of the present invention. This drawing information object maintains two keys that are used by the DataManagerCollections class: drawingID and drawingSEED. A drawingID is a key that is generated when a model drawing FIG. 4, 56) is created and is persisted in a corresponding AutoCAD file. A drawingSEED is a key that is generated every time a model drawing (FIG. 4, 56) is opened, regardless of whether the drawing is opened in AutoCAD or directly from computer memory. A model drawing (FIG. 4, 56) that is opened many times will have multiple DataManagerCollection objects associated with it. This is accomplished by mapping an instance of a model drawing (FIG. 4, 56) to a DataManagerCollection by using its drawingID and drawingSEED.

### DESCRIPTION OF A PREFERRED EMBODIMENT

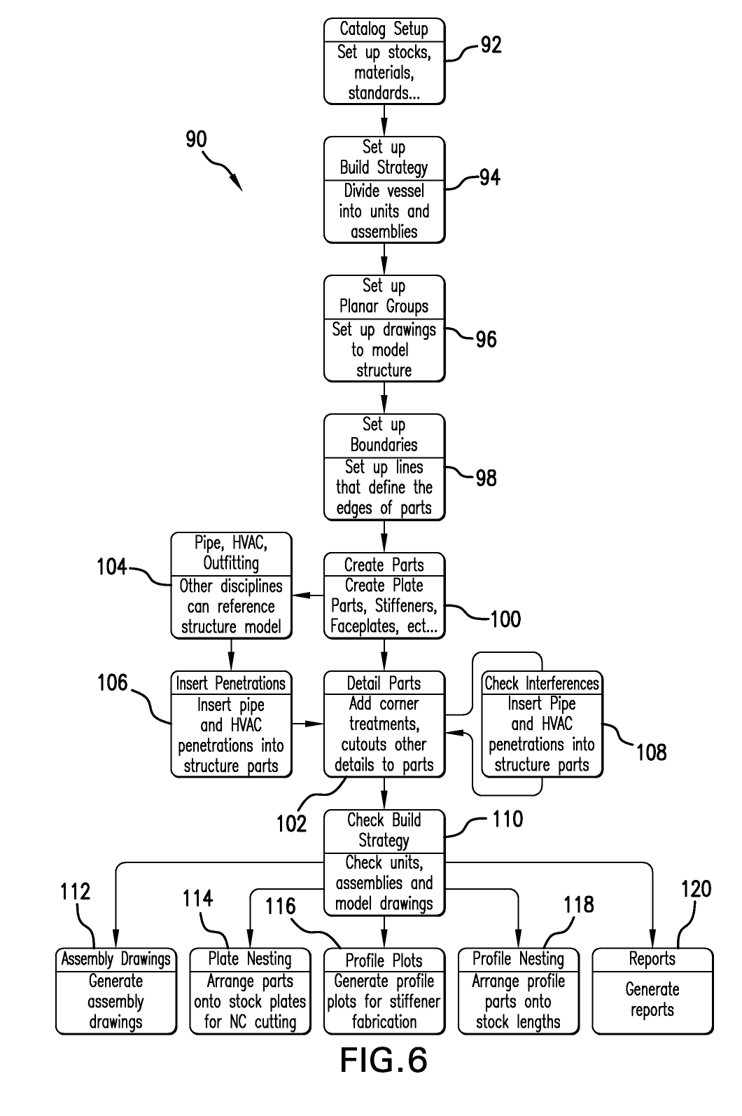

The description of FIG. 6 relates to a preferred embodiment of the present invention. It will be appreciated that the functionality of the entire software suite is separated into multiple modules, with the DDROM/Structure module being the primary module that enables the inventive functionality of the present invention. The end user may optionally purchase additional modules to enhance and augment functionality of the primary module, or the end user may opt to use third party software with the DDROM/Structure module of the present invention. However, it will be understood that the preferred embodiment of the present invention utilizes the DDROM/Structure module in conjunction with all of the optionally available additional modules provided by the manufacturer of the present invention's DDROM/Structure software platform, as well as the computer-aided design software platform known as AutoCAD. In this preferred embodiment the DDROM database uses a Microsoft SQL relational database, and the software of the present invention is executed on a computing device meeting the software manufacturer's minimum compatibility and performance specifications. As used herein the terms “model drawing” or “drawing” refers to computer-generated data stored on a data storage media. The invention may be implemented in digital electronic circuitry, or in computer hardware, firmware, software, or in combinations thereof. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits). Additionally, the DDROM/Structure module (primary module) of the present invention contains additional aspects and features not described herein that contribute to the functionality of the system, method and software of the present invention but are not necessary to describe the novel features of the present invention. These additional aspects and features are contained in the operator's manual provided with the software, and which is incorporated herein in its entirety by reference.

FIG. 6 is a flow chart illustrating a preferred conceptual design process 90, from beginning to end, for a three dimensional object, more particularly a vessel or ship, in accordance with the preferred embodiment of the present invention. Upon start up of the software of the present invention, various administrative functions are initiated on the computer executing the computer program code logic of the software. Some of these administrative functions (not shown in FIG. 6) check for; licensing of the software, number of individual modules of the entire platform suite added on to the DDROM/Structure module, proper user login, and the like. The project administrator(s) may also perform administrative functions at this point. Some examples of user performed administrator functions include but are not limited to; assigning user rights, assigning user access to various modules, setting up manufacturers, setting up equipment suppliers, setting up parts suppliers, etc.

Referring now to FIG. 6. The design process 90 includes administrative functions described in above but not shown in FIG. 6, and also includes additional administrative functions such as Catalog Setup 92 and Build Strategy Setup 94. When initiating a new project, items that will be used in the modeling of various aspects of the project must be defined. The Catalog Setup step 92 involves defining various items, including but not limited to: Standard Parts, Materials, Grades, Green Standards, Finishes, Stock parts, User Defined Attributes, and Common Parts Catalog, to be used in the modeling and design process. Standard parts, typically brackets, stiffeners or plate parts (when the project involves the design, for example, of a ship), are items that are commonly used as shipyard standards. Setting up such parts as standards allows them to be inserted by simply selecting them from a catalog during the design process. Materials and grades are also defined in a similar manner. Each part to be used in the project is fabricated from a specific type of material (for example, Aluminum 5086). In the software of the present invention a material can actually be a grouping that includes various grades of that particular material, for example, Aluminum 5086, 5052, 6061, etc. Green standards, both plate green and profile green, refer to a standard amount of extra material that is added to each part (e.g., plate parts and stiffener parts) fabricated to allow for production tolerances during final assembly of the materials. Stock parts are the raw materials from which parts to be used in the building process are fabricated. As those in the art will appreciate, for a given object class being designed or modeled (e.g., an onshore petroleum refining facility, a oil drilling platform, a cargo ship, etc.) there will be a number of stock parts. For example, in the context of ship design and building, some stock parts include, without limitation, plate stocks, corrugated plate stocks, profile stocks, and plank stocks. “User Defined Attributes” allow the user to define custom attributes to hold arbitrary data associated with a particular part (for example, model number, process codes, or custom identifiers), making it easier to manage parts.

Finishes, like paint or antifouling primer and enamel, must also be set up prior to their use in a modeling project. One of skill in the art will appreciate that a catalog of all the types of finishes usable in the production of an item designed using the system, method, and software of the present invention is beyond the scope of this application. However, it will also be understood that the present invention envisions all manner of finishes useful in the production of items that will be subject to various destructive forces or weather for prolonged periods.

In the context of FIG. 6, the “Common Parts Catalog” (CPC) is a shared catalogue of stocks that has been established by U.S. shipyards. The CPC shares part information within and between multiple shipyards and computer systems in order to streamline design, production, life cycle maintenance, business processes, and sharing and trading inventory. The software of the present invention also allows for importing or exporting any of these commonly used items from other modeling projects or third party applications or listings.

It will be understood by one of skill in the art that these items are described simply to illustrate useful aspects of the software of the present invention and do not represent all possible materials or standards that might be used in the design and fabrication of a vessel in accordance with the preferred embodiment of the present invention. It will also be understood that while the examples used in description of the preferred embodiment of the present invention are shipbuilding specific, items that are not shipbuilding specific are also easily modeled and designed using the systems, methods, and software of the present invention, due to the inventive manner in which a relational database is used to contain and represent the various parts of the object being modeled.

Returning to FIG. 6, once the project catalogs 92 and libraries are set up for the design project, a Build Strategy 94 must be set up. The Build Strategy 94 is the main Product Hierarchy created during the modeling process. The top level of the product hierarchy is always the project, and the project is always divided into units. Typically a build strategy 94 is set up by dividing the project (a ship or offshore platform in the preferred embodiment) into units (also called blocks) and assemblies based on how the project (vessel or offshore platform) will be assembled. In the case of the preferred embodiment, the size of a unit or block is usually determined by the maximum weight that the shipyard can handle. It will be appreciated that the concept of dividing projects into build strategies is easily adapted to other non-ship-building projects. Once all the unit breaks are determined, each unit can then be renamed in the software of the present invention, which also simultaneously creates a model drawing for that particular unit.

Assemblies are closely tied to product hierarchies. Using the preferred embodiment of the present invention as an example, product hierarchies consist of several levels. At the lowest level, individual parts are assembled to form minor assemblies. At the next level, minor assemblies are combined to form panels. At subsequent levels, panels are combined to form assemblies, assemblies are combined to form stages, stages are combined to form units, and units are combined to form the completed project.

Subsequent to setting up the Build Strategy 94, Planar Groups 96 are then defined. A planar group is a collection of parts that all lie within the same plane (again using the preferred embodiment as an example, a frame, a bulkhead, a girder, a deck, or a face on a deckhouse). Planar groups are also referred to as planar group drawings, two-dimensional (2D) planar groups, 2D planar group drawings, and group drawings. In general, a planar group is created for each major structural planar object by cutting sections through the hull surfaces. After creating planar groups, work is performed within each planar group, in 2D, to create the parts for that planar group. One advantage to the systems, methods, and software of the present invention is that planar group drawings can be created from within a unit drawing, 2D structural drawings, or hull drawings.

Once the Catalog 92, Build Strategy 94, and Planar Groups 96 are set up, the initial project Boundaries 98 are established. Boundaries are construction lines or drafting lines used to define and edit each part. These lines are meant to be for developing the production parts. Using the preferred embodiment of the present invention, boundaries are set up using three types of construction lines: HullTrace, PlanarGroupPlane, and User. Whenever a construction line is modified, all associated parts are automatically updated once the drawing is saved. Construction lines can be linked to another construction line, making it easy to modify one construction line and have all the changes applied to linked construction lines. When modifying a construction line by moving, rotating, extending, and so on, a preferred software embodiment of software of the present invention will display the Update Linked Objects window. The Update Linked Objects window displays all the linked construction lines and all the parts that use those construction lines. This window lets the user select which linked construction lines to apply the current modification to. For any of the linked construction lines that are checked, the current modification is applied to them and the parts that use them. For the linked construction lines that are not checked, no changes are applied to them, and the link (reference connection) between the construction lines is broken. It will be appreciated that the boundaries 98 or construction lines are concepts that are easily applied to non-ship design projects.

After the initial set up portion of starting a project, creating parts 100 that will be used to build the finalized object is started. The parts so created in the database preferably use a preferred embodiment of the instant DDROM systems, methods, and software. Using such a preferred embodiment as the example, this includes creating plate parts, stiffeners, faceplates, etc. (100); creating detailed parts (102), such as corner treatments, and cutouts as well as adding other detail to parts; outfitting Piping and HVAC (104); and Inserting Penetrations (106), which is tied to outfitting Piping and HVAC (104), because the pipes and HVAC ducting penetrate into structural or plate parts of the object being designed. It will be understood that these same steps are easily adapted to the design of non-ship items as well, as other types of vessels (airplanes, for instance) or buildings are also amenable to design and modeling using systems, methods, and software according to the invention.

After the design process has progressed to the point where the parts have been designed and fitment made in the overall model, two pre-production checks are made: Check interferences (108), where pipe and HVAC penetrations are inserted into structure parts; and a final check build strategy (110). Check Interferences 108 is an important step in this preferred software embodiment, as it is used to detect part collision problems or to add penetrations for pipe and HVAC through structure. The interference drawing can also be used as a virtual reality fly-through. Typically, an interference drawing is created that includes several planar group drawings within it and interferences are checked within the interference drawing. Interferences can also be checked from within a planar group drawing. The software of the present invention then checks the solids within the current drawing for collisions (the interferences). The software of the present invention also provides for minimum interference values, so that very small interferences that might be due to computer rounding errors or that are so small they would not be noticed during construction can be ignored. The final check prior to production is another Check Build Strategy 110. Again the units, assemblies and model drawings are checked to ensure that all portions of a model design are congruent and will fit when fabricated and assembled. This again involves checking the product hierarchy using the software of the present invention, as well as checking units, which involves checking the complete unit and its structure model drawings for errors. As will be appreciated, such software can performs this particular check in an automated fashion, and the software, except where a change in a standard would change the physical properties of the specified part, can repair any errors.

Once the final design checks are completed, the software can generate production drawings and reports to enable fabrication and assembly of the final product. Examples of the drawings and reports generated by the software of the present invention are: Assembly Drawings 112; Plate Nesting 114, where parts are arranged onto stock plates for Numerically Controlled (NC) cutting; Profile Plots 116, to allow for stiffener fabrication; Profile Nesting 118, where profile parts are arranged on stock lengths; and Reports 120. Reports 120 can also be generated for the entire project or specific portions (assemblies, units, planar groups, etc), or for particular classes of a design project, HVAC, or piping for example. Reports 120 can also be exported in various formats for presentation or other listings.

It will be appreciated that the systems, methods, and software of the present invention also provide additional functionality and benefits not described herein. While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claimed is:

1. A computer program product for designing and modeling any of a plurality of three dimensional parametric objects, wherein the computer program product resides on a computer readable medium and comprises a relational database, the database comprising:
a. a plurality of data tables;
b. within each data table a plurality of rows, wherein each row comprises geometric element data representing a distinct geometric element of a component of a parametric object; and
c. for each row, reference data for a plurality of references, comprising:
(i) structure reference data representing a structure comprised of the geometric element and at least one other geometric element defined in a different row within the relational database; and
(ii) relationship reference data representing a parametric relationship between the geometric element and at least one other geometric element defined in a different row within the relational database;
wherein the wherein the computer program product further optionally comprises one or more of the following:
computer readable program code for administration of a plurality of design/model projects;
computer readable program code for licensing of the computer product program code usage;
computer readable program code for at least one graphical user interface to allow for data input, modification, or manipulation from at least one user input device, wherein (i) the user input device optionally is selected from the group consisting of a keyboard, mouse, graphics tablet, and touch screen, and/or (ii) the data optionally relates to a requirement or attribute selected from the group consisting of ship type, offshore platform type, geometry, material type, material weight, material grade, build strategy, connection type, and paint or other finish type;
computer readable program code acting as an in-memory cache;
computer readable program code for managing parametric object datasets;
computer readable program code for managing and organizing a plurality of parametric object datasets such that multiple independent procedures during the design process can be manipulated independently of each other or in conjunction with each other, the manipulated datasets being saved in the relational object database as individual parametric objects or as a larger design/model project;
computer readable program code for accessing, designing, modeling, modifying, assembling and saving parametric objects representing a design/model project;
computer readable program code for analyzing and comparing a plurality of design/model projects or modification to a design/model project;
computer readable program code for output of a design/model project or a portion thereof, wherein the output is optionally selected from the group consisting of an electronic display, a plotter, a printer, and a viewing monitor;
computer readable program code for integration with third party program code; and
computer readable program code for producing documentation or executable commands to produce the design/model project created using the computer program product; and
wherein at least one of the plurality of three dimensional parametric objects is a specific component of an onshore or offshore platform, structure, transport vehicle, or transport vessel, wherein the transport vehicle or transport vessel optionally is selected from the group consisting of a cargo ship, a tanker, a freighter, a transport ship, mining ship, fishing ship, salvage operation ship, exploration ship, icebreaker ship, offshore mining structure, offshore oil drilling structure, offshore refueling station, and offshore exploration platform.

2. A computer program product according to claim 1, comprising at least one of the following:
a. geometric element data includes data representing information selected from the group consisting of points, lines, transformations, assemblages of points and lines, other geometric shapes, and larger objects comprised of points, lines, transformations, and other geometric shapes;
b. structure reference data includes data representing information selected from the group consisting of connectors between data tables, geometric elements, transformations, parametric relationships, and assemblages of a plurality of data tables, geometric elements, transformations, and parametric relationships.

3. A computer program product according to claim 1, wherein the computer program product enables a computer executing the same to group similar parametric objects into classes of objects, said objects optionally operated on as Active X Data Objects (ADO) datasets in the computer program product.

4. A computer-aided method for designing a three-dimensional object, comprising using a computer configured to execute computer program logic that utilizes a relational database comprised within a computer program product according to claim 1 in order to design the three-dimensional object.

5. A computer aided method according to claim 4, further optionally comprising at least one of the following steps:
a) planning the production of a three dimensional object; and/or
b) after designing modeling the three-dimensional object producing documentation and/or executable commands to enable fabrication and assembly of the three-dimensional object.

6. A computer aided method according to claim 5, wherein the three-dimensional object represents a specific component of an onshore or offshore platform, structure, transport vehicle, or transport vessel, wherein the transport vehicle or transport vessel optionally is selected from the group consisting of a cargo ship, a tanker, a freighter, a transport ship, mining ship, fishing ship, salvage operation ship, exploration ship, icebreaker ship, offshore mining structure, offshore oil drilling structure, offshore refueling station, and offshore exploration platform.

7. A computer aided method for modifying a design of a three-dimensional object, comprising using a computer configured to execute computer program logic that utilizes a relational database comprised within a computer program product according to claim 1 in order to modify the design of the three-dimensional object.

8. A computer aided method according to claim 7, further optionally comprising the steps of:
a) identifying at least one previously defined geometric element and/or reference to be modified in the relational database for the three-dimensional object;
b) modifying in the relational database the geometric element data or reference data for the identified geometric element(s) and/or reference(s); and
c) after modifying data in the relational database, producing documentation and/or executable commands to enable fabrication and assembly of the modified three-dimensional object.

9. A computer aided method according to claim 8, wherein modification of geometric element data or reference data in the relational database elicits a query regarding local or global application and dispersion of the modification(s) in the relational database.

10. A relational database driven designing and/or modeling system comprising:
a) a computer configured to execute computer program logic that utilizes a relational database comprised within a computer program product according to claim 1; and
b) the relational database in a form that can be utilized by the computer.

11. A structure designed using a relational database driven designing and/or modeling system according to claim 10.

12. A structure according to claim 11 that comprises an onshore or offshore platform, transport vehicle, or transport vessel, wherein the transport vehicle or transport vessel optionally is selected from the group consisting of a cargo ship, a tanker, a freighter, a transport ship, mining ship, fishing ship, salvage operation ship, exploration ship, icebreaker ship, offshore mining structure, offshore oil drilling structure, offshore refueling station, and offshore exploration platform.
